(19) United States
(12) Patent Application Publication
(10) Pub. No.: US 2010/0223105 A1
(43) Pub. Date: Sep. 2, 2010

(54) METHOD AND APPARATUS FOR CONTENT TARGETING ONE USER GROUP BASED ON BEHAVIORAL PROFILING OF ANOTHER USER GROUP

(75) Inventors: Michael Gassewitz, Ottawa (CA); Denny Lung Sun Lee, Ottawa (CA); Wang Wu, Los Altos, CA (US); Haijun Cao, San Francisco, CA (US)

Correspondence Address: OSHA LIANG L.L.P., TWO HOUSTON CENTER, 909 FANNIN, SUITE 3500, HOUSTON, TX, 77010, US

(73) Assignee: KINDSIGHT, INC., Sunnyvale, CA (US)

(21) Appl. No.: 12/714,202

(22) Filed: Feb. 26, 2010

Related U.S. Application Data
(60) Provisional application No. 61/156,216, filed on Feb. 27, 2009.

(51) Int. Cl. G06Q 10/00; G06Q 50/00; G06Q 30/00

(52) U.S. Cl. 705/10

(57) ABSTRACT

A system and method for selecting an accompanying content, such as an advertisement, for presentation with a main content, such as a web page is described. The system and method provide a profile of the main content that is used when selecting the accompanying content. The main content profile may be used to select the accompanying content when the main content is requested by a user for which little or no profile information is available. The main content profile is based on the content consumption history of a group of users for which profile information is available.

### CROSS-REFERENCE TO RELATED APPLICATIONS

This application claims priority under 35 USC 119(e) to U.S. Patent Application No. 61/156,216 filed Feb. 27, 2009, herein incorporated by reference.

### BACKGROUND OF INVENTION

1. Technical Field

The present disclosure relates to the field of profiling and targeted content selection and delivery. In particular, to an apparatus and a method for content targeting one user group based on behavioral profiling of another user group.

2. Background

Typically an item of main content (e.g. digital media content) can be described and associated with its context. In the domain of web content, the context of, for example, a webpage refers to that to which the text of the webpage refers. The term ‘web’ in this document refers to the World Wide Web (a.k.a. WWW). In the domain of multi-media content, the context of, for example, a video clip typically refers to its genre or alternatively to a story conveyed by the video. A plurality of content items, in a variety of formats, are widely available on the Internet (e.g. a publicly accessible article on a news website). Further, a plurality of consumers (e.g. the general public) are free to consume (e.g. read, view, listen, etc.) the content items (i.e. the content).

In addition, other content types, such as advertisements, can be presented alongside (i.e. in association with) the main content. The format for presenting the other content type can, for example, be spatial (e.g. advertisement embedded as part of a webpage), or temporal (e.g. a pre/post-roll video advertisement in a video clip), or a combination of spatial and temporal. These other content types, in particular advertisements, are often selected and presently based on contextual targeting or on behavioral targeting methods. Contextual targeting refers to selecting and presenting advertisements that are contextually related to the main content. Behavioral targeting typically refers to selecting and presenting advertisements that are related to the profile (e.g. interests, purchase intent, demographic, psychographic, or similar characteristics) of a consumer that is currently requesting the main content. In the case of behavioral targeting the advertisement typically does not have any contextual relationship with the main content.

In general, the deeper and the wider the scope of knowledge for a particular consumer of the content, the better the behavioral targeting performance of the advertisement (i.e. measured in terms of higher relevancy and improved click-through rate, for example). When the scope of knowledge for a particular consumer is significant, behavioral targeting can be more effective than contextual targeting. However, if a consumer does not have an associated profile, or has a narrow profile, behavioural targeting is not possible, or is not as effective.

Therefore there is a need for an improved behavioral targeting of other content to consumers for which little or no behavioral profile information is available.

### SUMMARY OF INVENTION

There is provided a method of selecting an accompanying content for display with a main content. The method comprises receiving, at a content selection component executing on a computer, a main content identifier (ID) uniquely identifying the main content, the main content requested by a user over a network connection using a computing device, the main content comprising content for presentation to the user on the user computing device. The method further comprising retrieving, from a repository, a main content profile associated with the received main content ID, the main content profile based on extended user profiling information of a plurality of extended knowledge users that have requested the main content associated with the received main content ID and requesting an accompanying content based on the retrieved main content profile, the accompanying content for presentation to the user with the main content.

There is further provided a system for selecting an accompanying content for display with a requested main content. The system comprises an event generator component comprising a processor for executing instructions and a memory coupled to the processor for storing instructions, the instructions configuring the processor and the memory to generate events, each event associated with a respective user, when consumption of main content occurs by one or more users; an aggregate event store storing on a computer readable memory aggregate event information from the generated events associated with one or more user's that are part of an extended knowledge user group; a main content profiler component comprising a processor for executing instructions and a memory coupled to the processor for storing instructions, the instructions configuring the processor and the memory to generate main content profiles for main content associated with a respective main content identifier (ID) based on the aggregate event information associated with users that have accessed the respective main content; a main content profile store storing on a computer readable medium main content profiles generated by the main content profiler component; and an accompanying content selector component comprising a processor for executing instructions and a memory coupled to the processor for storing instructions. The instructions configure the processor and the memory to receive a main content ID uniquely identifying the requested main content, the requested main content requested by a user over a network connection using a computing device, the requested main content comprising content for presentation to the user on the user computing device; retrieve from the main content profile store the main content profile associated with the main content ID of the requested main content; and request an accompanying content based on the retrieved main content profile, the accompanying content for presentation to the user with the main content.

There is further provided an apparatus for selecting an accompanying content for display with a requested main content. The apparatus comprises a processor for executing instructions; and a memory coupled to the processor for storing instructions. The instructions configure the processor and the memory to receive a main content identifier (ID) uniquely identifying the requested main content, the requested main content requested by a user over a network connection using a computing device, the requested main content comprising content for presentation to the user on the user computing device; retrieve a main content profile associated with the main content ID of the requested main content, the retrieved main content profile based on aggregate event information stored in an aggregate event store associated with users that have accessed the requested main content; and request an accompanying content based on the retrieved main content profile, the accompanying content for presentation to the user with the main content.

Other aspects and features of the present disclosure will become apparent to those ordinarily skilled in the art or science to which it pertains upon review of the following description of specific embodiments of the disclosure in conjunction with the accompanying figures.

### BRIEF DESCRIPTION OF DRAWINGS

The present disclosure will be described in conjunction with drawings in which:

FIG. 1 is a schematic representation of an operating environment in which the present disclosure can be used;

FIG. 2 is a schematic representation of a system for content targeting one user group based on behavioral profiling of another user group;

FIG. 3 is flow diagram representing of a method for content targeting one user group based on behavioral profiling of another user group;

FIG. 4 is a flow diagram representing a method of generating a main content profile; and

FIG. 5 is a flow diagram representing a method for selecting an accompanying content to be displayed with main content.

### DETAILED DESCRIPTION

A method and an apparatus for content targeting one user group based on behavioral profiling of another user group is provided. A publisher of main content (e.g. web pages) leverages a deep and wide knowledge (embodied in profiles associated with a plurality of extended knowledge users) in selecting accompanying content (e.g. advertisements) to be presented to one or more lesser knowledge users when these users consume an item of main content (e.g. view a web page).

The present disclosure addresses the problem that the publisher of the main content might have a varying degree of knowledge for each of the plurality of consumers that are requesting a particular item of main content. Behavioral targeting of accompanying content to consumers for which little or no behavioral profile information is available (i.e. lesser knowledge users) can be improved by enabling the publisher of a main content item to leverage the deep and wide knowledge of a small subset of consumers (i.e. the extended knowledge users), of the main content item, to be applied to the lesser knowledge users when they consume the same item of main content, thus resulting in improved accompanying content (e.g. advertisement) targeting performance for the lesser knowledge users.

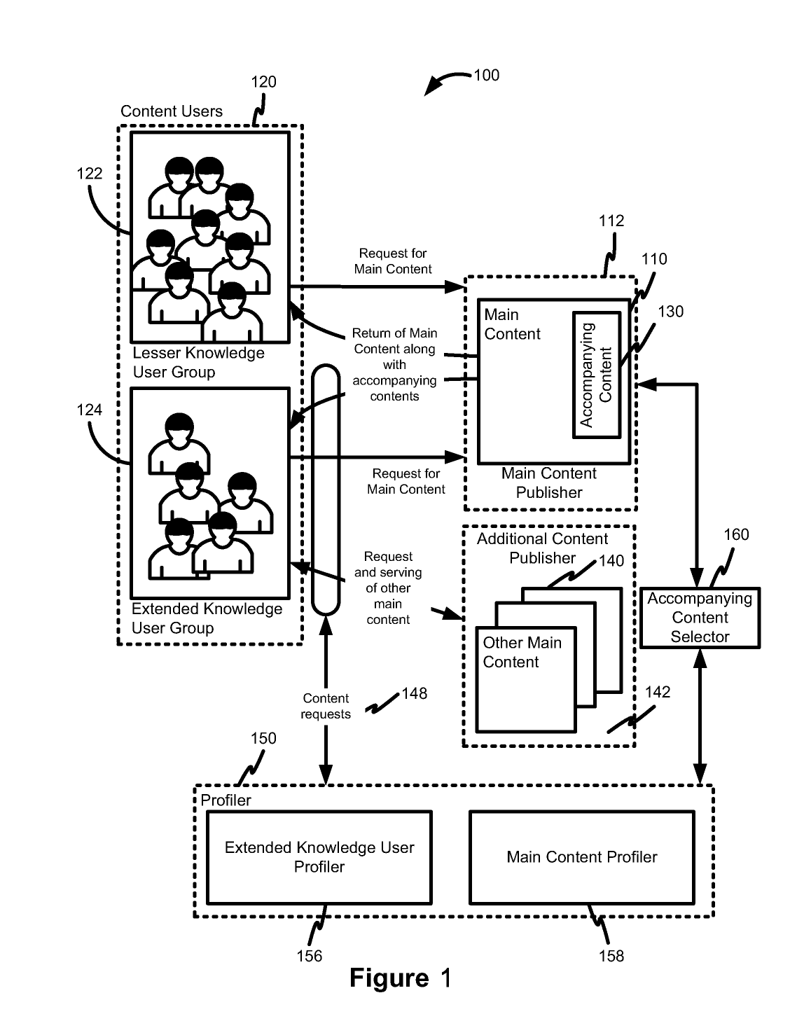

FIG. 1 is a schematic representation of an illustrative operating environment 100 in which the present disclosure can be used. As depicted in FIG. 1, a group of content consumers 120 (or simply consumers) can request and receive content from a publisher 112. The requested content may include a main content 110 and an associated accompanying content 130. As an illustrative example, a main content 110 may be a web page, and an accompanying content may be an advertisement embedded within the web page. It is appreciated that, as described further herein, the main content and accompanying content are not limited to web pages and advertisements.

The publisher 112 can have one or more items of main content 110. An example of a publisher 112 of main content 110 can be a website publisher on the Internet. Each website can contain multiple sections (i.e. groups of webpage) and each section can contain one or more web pages. A main content item 110 can comprise a single webpage, or alternatively the main content item 110 can comprise a plurality of webpages, or a section of the website (e.g. www.example.com/sports). A display advertisement, a product recommendation, another content item recommendation, or combinations thereof can comprise an accompanying content 130. In another example, the publisher can be a video clip aggregator having one or more video clips that each can be a main content item. A pre-roll/post-roll advertisement can comprise the accompanying content. The main content item 110 can comprise a single video, a plurality of videos (e.g. a playlist), or a section of a video distribution service that contains a set of videos. Note that each main content item 110 can have associated with it one or more items of accompanying content.

The consumers 120 may be comprised of two groups of users, namely a lesser knowledge user group 122 and an extended knowledge user group 124. The content requests 148, and other network activities, which may be referred to collectively and generally as events, of users of the extended knowledge user group 124 are processed by a profiling component 150. Events of users of the lesser knowledge user group are not processed by the profiling component 150, or may not be uniquely associated to a user of the lesser knowledge user group 122.

Regardless of which group 120, 124 a user belongs to, when the user requests a main content item 110 from the publisher 112, the main content 110 along with an accompanying content item 130 is served back to the requesting user. The serving of the main content 110 and the accompanying content 130 need not be handled by the publisher 112 directly. For example, the accompanying content 130 can be served by a contracted or partnering entity to the publisher 112. In the case of the accompanying content 130 being an advertisement, the accompanying content can be served via a partner advertisement (ad) network's ad server.

In addition, both a user of the lesser knowledge user group 122 and a user of the extended knowledge user group 124 can also consume other main content items 140 (which can have associated within them accompanying contents 130 as well) from additional publishers 142. A profile processor 150 can have access to the extended knowledge user group's consumption of the main content 110 as well as to the consumption of other contents items served by the additional publishers 142. Consumption of content items is typically represented as events. There can be many types of event including, for example, page-views (i.e. visit to particular webpage represented by its Universal Resource Locator (URL)), search terms, advertisement (ad) view, ad clicked (including a landing page URL), media selection indicator (e.g. selection of video or music clip), media consumption information (e.g. genre, artist information, and/or other metadata associated with the media), product buying indicator (e.g. online purchase/transaction), shopping cart transaction, and other similar types of events.

The profiling component 150 includes an extended knowledge user profiling component 156 and a main content profiler component 158. The extended knowledge user profiler component 156 processes the events associated with a user of the extended knowledge user group 124 and generates, or updates, an extended user profile associated with the user. The extended user profile provides a classification of the extended knowledge user's interests based on the events. The extended user profile is a user profile for a user in the extended knowledge user group 120.

The main content profiler component 158 generates, or updates, a profile for a main content 110 based on extended user profiling information. The extended user profiling information may be determined for users of the extended knowledge user group. Unlike contextually targeted advertisement systems, which may have a context profile associated with the main content based on the context and content of the main content, the profile for the main content 110 generated by the main content profiler component 158 is based on a plurality of extended user profiles of users that have viewed the main content. As such the main content profile is a profile of the interests and behaviour of users that have viewed the content, rather than simply a description or categorization of the content itself

When a consumer requests a main content 110 associated with an accompanying content, the accompanying content is retrieved from an accompanying content selection component 160. If the main content 110 request includes an user identifier that can be used to retrieve an extended user profile from the profiling component, the accompanying content selection component 160 selects the accompanying content based on, at least, the extended user profile. If the request doesn't include a user identifier that can be used to retrieve an extended user profile, the accompanying content selection component 160 can select the accompanying content based on, at least the main content profile associated with the requested main content 110.

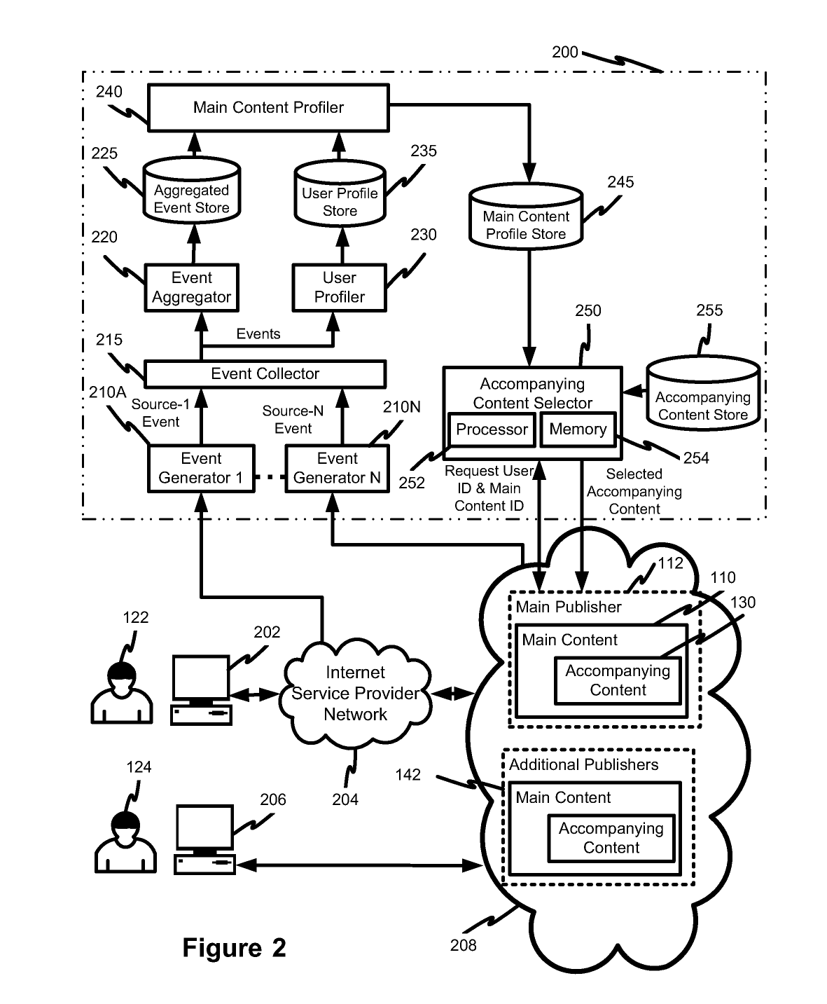

FIG. 2 is a schematic representation of an illustrative embodiment of a system 200 for content targeting one user group based on behavioral profiling of another user group. The system 200 comprises one or more event generators 210A-210N, an event collector 215, an event aggregator 220, an aggregate event store 225, a user profiler 230, a user profile store 235, a publisher main content profile generator 240, a publisher main content profile store 245, an accompanying content selector 250, and an accompanying content store 255. User 122, 124 consumes main content from either the main content publisher 112 or additional publishers coupled to the internet 208. The users 122, 124 may use computer or computing devices 202, 206 coupled to the Internet 208 in order to consume the main content. The user's 122 computer 202 is coupled to the Internet through an ISP provider network 204.

The system 200 can comprise one or more types of event generators 210A and 210N (referred to generally as event generator 210). For each type of event generator 210, there can be more than one physical device that provides the event generating function (e.g. to provide scalability). Each type of event generator 210 is responsible for receiving information regarding content consumption by users in the extended knowledge user group 124. For example, one type of event generator, depicted as event generator 210A, can be a network traffic monitoring probe that has access into an Internet Service Provider (ISP) network 204. With this type of event generator, extended knowledge users' (e.g. subscribers of the ISP) network traffic can be monitored while it traverses the ISP network 204 between the user's computer and the public Internet or other content providing space. Another type of event generator (not shown) may be used in connection with a video on demand service offered by an ISP network, which may provide a walled-garden type of service. In another type of event generator depicted as event generator 210N, a source content consumption indicator can come from a web analytic entity in which a cookie is deposited in the user's computer. The cookie embeds within it a web analytic entity assigned user identifier (ID). The user ID is globally unique and is used to track the user's navigation across the entire Internet. This type of cookie is often referred to as a 3rd party cookie. The web analytic entity can provide the webpage visits, as well as other observable web activities as inputs into the event generator 210. Regardless of the type of event generator, when the event generator receives the appropriate input, for example Internet or ISP network traffic, video requests from a video on-demand service, or other content consumption indicators, output events are generated.

Events output by the event generator 210 can include, for example, information related to page-views, search, ad viewed, ad clicked, channel change information, media metadata, eCommerce site's wish list and shopping cart transaction, and other similar event types. Each event is accompanied by a timestamp and a user identifier (ID) (e.g. source Internet Protocol (IP) address of the subscriber or the user).

The event collector 215 may aggregate, collate, and transform the various incoming events from a plurality of event generating devices, of one or more types of event generators 210, into a common event format. The output of the event collector 215 may be a stream of well-formatted (i.e. having defined syntax) events. Each event may be accompanied by a timestamp of the occurrence of the event and a user ID, such as an IP address or subscriber ID, that is associated with user of the extended knowledge user group whom initiated the event.

The event collector 215 also provides the following function. When the incoming source information input to each event generator 210 is not pre-filtered, the event collector 215 also serves to filter out any unnecessary or inappropriate events. In one example, the event collector 215 filters out events that contain personal data in order to ensure a high standard of privacy protection for the user.

The system 200 may comprise an event aggregator 220. The event aggregator 220 may receive a well-formatted output event stream output from the event collector 215 and stores it in the aggregate event store 225. If the event aggregator 220 is not present, the event collector may store the output events of the output event stream in the aggregate event store 225. The inclusion of an event aggregator 220 may provide additional scalability to the system by enabling multiple event generators to report into an event aggregator.

The system 200 may further comprise a user profiler component 230. The user profiler component 230 generates a user profile for a user based on output event stream output of the event collector 215. The user profiler component 230 stores the user profile in a user profile store. The user profile provides a summary of the user profiling information based upon the event stream output. The event stream output may be stored or aggregated and stored in the aggregate events store 225. The use of the user profiler component 230 is dependent on the type of the publisher profiling algorithm that is employed. The publisher profiling algorithm may utilize the user profiles stored in the user profile store 235 as the user profiling information, in which case the user profiler 230 is required in order to generate/update the user profiles. For example, the publisher profiling algorithm may utilize information stored in the aggregate event store 225 to determine the users that have consumed a particular main content, and then use the user profile store 235 to determine characteristics about these users. Additionally or alternatively the publisher profiling algorithm may access only the information stored in the aggregate event store, in which case the user profiler component 230, as well as the user profile store 235 is not required. The publisher profiling algorithm may include the functionality used by the user profiler component 230 and generate the user profiling information used to generate the main content profile, from the output event stream output, or the aggregated output events, stored in the aggregate event store.

The aggregate event store 225 may be a storage element (e.g. database or repository) that contains events that are aggregated together, typically in a per-user, time-linear, fashion. The aggregate event store 225 stores events that capture (i.e. represent) consumption or activities related to the main content initiated by the extended knowledge user group 122. The aggregate event store 225 may store click-stream data for the extended knowledge user group 122 when an incoming event is generated from Internet traffic. The click-stream may be a series of events organized, per the user, in a time-linear fashion. The timestamps associated with the events can be used as an indicator to determine the chronological order of events. Although referred to as an aggregate event store, the events may be stored without aggregating them. By aggregating the events before storing them, the processing of the aggregate event store 225, for example by the publisher profiling algorithm may be more time efficient, however un-aggregated events may be stored in the aggregate events store 225 and used by the publisher profiling algorithm.

The user profiler 230 takes the well-formatted event stream output from the event collector 215 and uses each event as input to calculate an output profile score for the user associated with each event. The calculation of the output profile score may be based on a user profiling algorithm. The user profiling algorithm used by the user profiler may be preconfigured and prepared offline (i.e. not in real-time). Alternatively, the algorithm may be periodically updated or dynamically modified.

Regardless of how the algorithm of the user profiler 230 is configured, the user profiler 230 uses incoming events as input and performs a real-time profile score calculation and updates the extended user profile for the user associated with the event. The extended user profile may comprise a user profile of a user of the extended knowledge group, and may be stored in the user profile store 235. Each user profile stored in the user profile store may correspond to an extended user profile, or alternatively only a subset of the user profiles stored in the user profile store may correspond to extended user profile. Whether a user profile is considered an extended user profile may be based on the amount of events that have been used in generating and updating the user profile. Typically the profile score calculated for a user can be represented as a series of category and category-score pairs, in which the category-score value reflects the relative degree of interest of that user in the category. A category can be a class of product such as, for example, “auto” (i.e. automobile), a type of product such as “fiction novel”, or demographic, or psychographic category. An alternative representation of the profile score can be in the format of a series of keyword and keyword-score pairs. The keyword is, in this case, a descriptor that is related to the user. The relationship can, for example, reflect the content or product interests of the user, the behavioral characteristic, the demographic, psychographic, and other similar characteristics of the user. The keyword-score is correspondingly a relative value (in numeric format) that represents the degree of relevancy of that keyword to the user.

The user profile store 235 is a storage element (e.g. database or repository) that stores the user profiles. Each user profile is identified by a user ID or another identifier (ID) that can be uniquely derived from the user ID. The profile for each user may be a set of category/category-score pairs and/or keyword/keyword-score pairs; or other similar profile representation.

The publisher main content profile generator 240 has access to data stored in the aggregate event store 225 and the user profile store 235 when either is present in the system 200. The aggregate event store can provide an indication of the users that have accessed a particular main content, as well as how often the user has consumed the content. The user profile store may provide an indication as to the behaviour, or interests of a user. The data in these storage devices are used as input to generate a profile for the main content 110. The publisher main content profile generation process can be performed in real-time (i.e. the profile update occurs when either storage data changes) or non-real time (i.e. the profile update occurs periodically or is manually triggered). The publisher main content profile generation process is based on a publisher profiling algorithm that is pre-configured in the publisher main content profile generator 240. Examples of the publisher profiling algorithm include item-based collaborative filtering algorithm, user-based collaborative filtering algorithm, or other similar nature data mining algorithm, or a combination of these algorithms. Alternatively, or additionally, a heuristic-based algorithm can be used alone or in combination with any of the algorithms mentioned in preceding description.

The publisher profiling algorithm takes data stored in the aggregate event store 225, or alternatively the aggregate event store 225 and the user profile store 235 and determines a main content profile associated with the publisher's main content 110. The main content profile is based on user profiling information, which may be represented by information stored in the aggregate event store, and optionally the user profile store. The main content profile reflects a summary of the users' that consumed the main content 110—that is, an aggregation of the subset of the extended knowledge user group 122 that has previously consumed the main content 110. The publisher profiling algorithm may be a data mining type of algorithm. The publisher profiling algorithm may be used to derive an overall product/content interests, demographics, psychographics, or other similar characterization of the subset of users within the extended knowledge user group 122 that has consumed the main content 110 by data mining the user profiling information that are stored in the aggregate event store 225, and optionally the user profile store 235. The main content profile provides an aggregation or summary of the characteristics of the users, and in particular the extended knowledge users, that have previously consumed the main content. The main content profile may be used as an assumed profile of a user for which no, or little, profile information is available.

As an alternative, or in addition to the data mining profile algorithms described above, the publisher profiling algorithm can also include summarization of the user profile scores found in the user profile store 235 for the subset of users that have consumed the main content 110. This aspect of the publisher profiler algorithm can utilize a heuristic-based or another rules-based algorithm to arrive at (i.e. to derive) an aggregate user profile. The aggregate user profile represents the subset of users that have previously consumed the main content 110. The format of the aggregate user profile can use any of the representation formats described above with reference to the user profile.

A publisher profiling algorithm can be chosen, for example, by trying different algorithms, measuring the performance according to one or more criteria (e.g. consumption rate), and choosing an algorithm based on the associated performance in one or more criteria. One example format is to represent each event as a set of attributes and attributes values. An attribute can be, for example, “page-view URL” and the attribute value can be, for example, “www.example.com” in the case of a page-view event. In another example, the attribute can be “tv channel number”; and the attribute value can be “5” in the case of a television (TV) channel 5 selection. In yet another example format, an event can be represented by a keyword and keyword-score pair. Each keyword is a descriptor that is associated with the event, and the keyword-score reflects how strongly the keyword describes or is associated with the event. The keyword could, for example, be part of the content itself (such as keywords extracted from a webpage visited), or can be metadata associated with the event (such as an artists name associated with a film clip viewing event).

The publisher profiling algorithm may be used to generate a main content profile associated with the main content and the main content profile may be stored in the main content profile store 245. The format of the main content profile is described below.

The main content profile store 245 is a storage element (e.g. database) that contains a plurality of main content profiles. Each main content profile is identified by the main content ID or an ID that can be uniquely derived from the main content ID. For example a main content ID can be a URL that points to the main content 110 (e.g. www.example.com/sports). The main content profile for each main content 110 may be one or more category/category-score pairs and/or keyword/keyword-score pairs; and/or other equivalent representation.

The accompanying content selector 250 comprising at least a processor 252, memory 254 and a network interface (not shown), is triggered when the main content 110 is requested by a user. In an illustrative scenario, when a lesser knowledge user 124 requests the main content 110 from the publisher, the publisher content server forwards the request along with the requesting user ID, such as an IP address or subscriber ID, to the accompanying content selector 250. This can be done directly (e.g. through a server to server interface) or alternatively can be redirected (e.g. in the case of advertisement embedded within a web content). In the illustrative scenario, the advertisement is the accompanying content 130 and the web content is the main content 110. Typically, the request for selecting and delivering of the advertisement is done through a redirection using embedded Hyper-text Markup Language (HTML) code within the web page. The redirection causes the user's web browser to obtain advertisements from an ad server that contains an advertisement (ad) selector (i.e. an accompanying content selector). When the accompanying content selector 250 receives the request, it may determine if the user ID is associated with an extended user profile. If no extended user profile is associated with the user ID, or if no user ID is included in the request received at the accompanying content selector, it attempts to retrieve the behaviourally targeted ads based on the main content profile associated with the main content. The accompanying content selector retrieves the publisher main content profile based on a main content ID (e.g. a URL) from the publisher main content profile store 245. The retrieved main content profile is then used to select one or more suitable accompanying content items 130. The selection can be based on relevancy or closeness of the accompanying content 130 as compared to the publisher main content profile score (i.e. the category/category-score pairs, keyword/keyword-score pairs, and/or other equivalent representation). The accompanying content 130 itself can have associated with it a set of attributes or descriptors that use the same representation as the publisher main profile score. The relevancy or closeness can be determined by matching the category and/or keyword found in the publisher main content profile against the accompanying content's attributes/descriptors. For example, a direct match of a certain category with a high category-score value would signify a strong relevancy or closeness. In addition, the accompany content 130 can optionally have attributes that are associated with the revenue-generating ability of that particular accompanying content. For example, for online text ad, this could be the cost-per-click a marketer is willing to pay when the ad is clicked on. In this case, the accompanying content selector 250 is equipped with a selection function that takes into account revenue maximization business rules, in addition to the relevancy and closeness assessment function described above.

The accompanying content store 255 may be a storage element (e.g. database or repository) that contains a plurality of accompany content items 130. Each accompany content item 130 is stored with an accompanying content identifier (ID), the accompanying content item itself, attributes and/or descriptors, that are associated with the accompanying content 130. One example type of accompanying content 130 is advertisements.

The selected accompanying content 130, as well as the requested main content 110, are served to the requesting user. This serving aspect can be accomplished via a single content server (not illustrated) in which the selected accompanying content 130 (including a plurality) is embedded within the main content 110 (e.g. in the scenario of embedding video ad into a film clip). Alternatively, this serving aspect can be accomplished via a parallel content server (not illustrated) in which the main content 110 and the accompanying content 130 are served independently to the requesting user.

In the above descriptions the present disclosure has been illustrated for leveraging the extended knowledge user group's 122 consumption of the main content 110 for profiling and for selection of accompanying content 130 for the lesser knowledge user group 124. However, this present disclosure is also equally applicable for selecting and serving accompanying content 130 to an extended knowledge user 122.

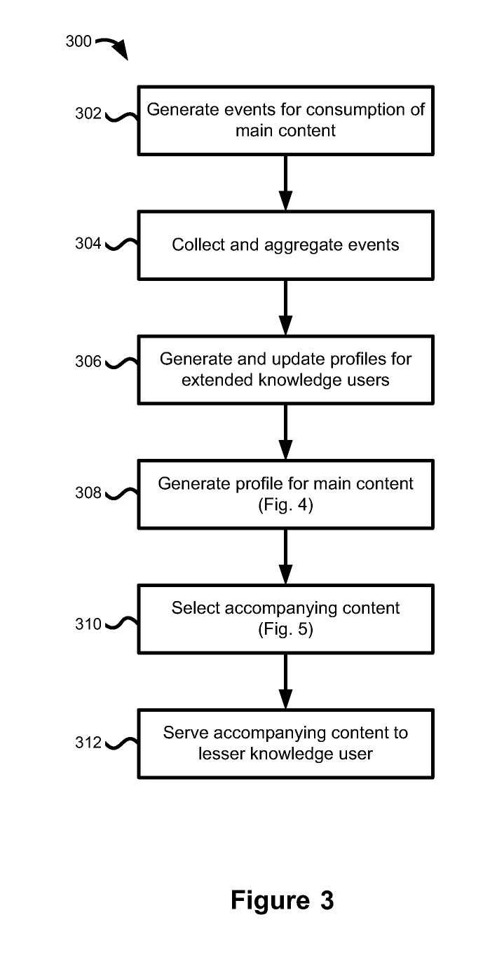

FIG. 3 is a flow diagram representing a method 300 for content targeting one user group based on behavioral profiling of another user group. The method 300 according to the present disclosure can be implemented using the system 200 described above with reference to FIG. 2. Alternatively, the method 300 according to the present disclosure can be implemented using computer executable program instructions stored on a computer-readable storage memory for execution by a processor. At 302, events are generated when the main content 110 is consumed by users in accordance with the description above under the heading ‘Event Generator’. At 304, events are optionally collected and aggregated in accordance with the description above under the headings ‘Event Collector’, ‘Event Aggregator’, and ‘Aggregate Event Store’. At 306, profiles are generated for extended knowledge users 122 in accordance with the description above under the headings ‘User Profiler’ and ‘User Profile Store’. A profile is generated for main content 110 in accordance with the description above under the headings ‘Publisher Main Content Profile Generator’ and ‘Publisher Main Content Profile Store’ at 308. Accompanying content 130 is selected at 310 when a lesser knowledge user 124 requests the main content in accordance with the description above under the headings ‘Accompanying Content Selector’ and ‘Accompanying Content Store’. At 312, accompanying content 130 selected at 310 is served to the lesser knowledge user 124 together with the requested the main content 110.

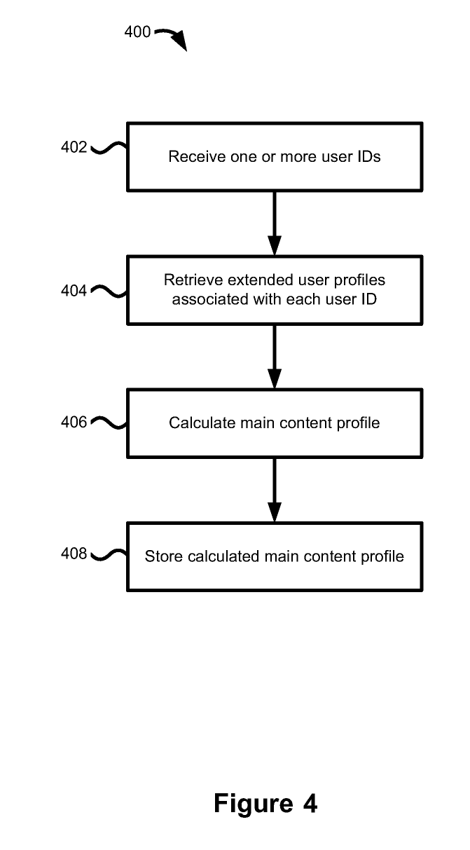

FIG. 4 is a flow diagram representing a method 400 of generating a main content profile. The method 400 receives one or more user IDs 402 who have requested the main content previously. The user IDs associate a user of the extended knowledge group with an extended user profile. The user IDs may be determined in various ways, for example, the aggregate event store may be processed to identify subscriber that have consumed the main content. Regardless of how the user IDs are determined, the extended user profiles are retrieved that are associated with the respective user IDs 404. Based on the extended user profiling information that has been captured in the extended user profiles, the main content profile is calculated 406. For example, the main content may be a simple average of the retrieved user profiles. Alternatively, the main content profile may be based on a weighted average of the retrieved extended user profiles, with the weighting based on, for example, the number of times a user has consumed the main content. Once the main content profile is calculated, it is stored 408.

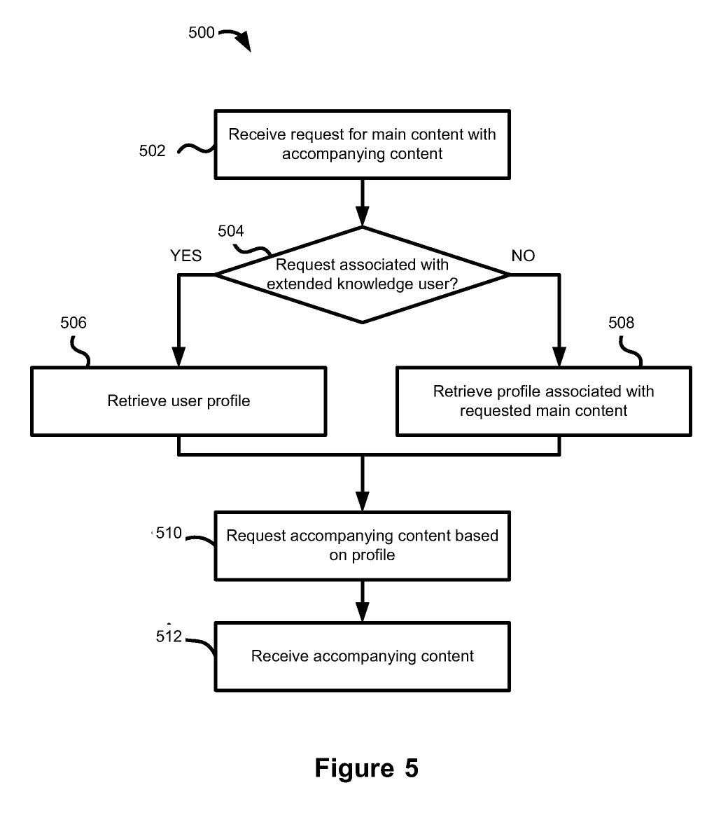

FIG. 5 is a flow diagram representing a method 500 for selecting an accompanying content to be displayed with main content. A request for the main content with accompanying content is received 502. The request includes an identification of the main content, which may be for example an URL address of the requested main content. The request may also include an indication of the user making the request, such as an IP address or a subscriber ID. The method determines if the received request is associated with a user for which there is an associated extended user profile 504. This may be done in various ways, for example, if the extended user profiles are associated with a subscriber ID, and the request only includes an IP address, it can be determined that the request is not associated with an extended user profile. Alternatively, if the extended user profiles are associated with an IP address, an attempt may be made to retrieve the associated extended user profile, and if it fails, it is assumed that the request is not associated with an extended user profile.

Regardless of how it is determined, if the request is associated with an extended user profile, YES at 504, the extended user profile is retrieved 506. If however, the request is not associated with an extended user profile, NO at 504, the main content profile associated with the requested main content is retrieved 508. The main content profile may be retrieved using the main content identifier such as the URL of the main content.

Once the profile is retrieved, whether it is an extended user profile or main content profile, accompanying content is requested based on the profile 510, and received 512. The request for accompanying content may result in a plurality of accompanying contents being returned, in which case one is selected, for example based on a similarity to the main content, or extended user profile, or main content profile, or combination of.

It will be apparent to one skilled in the art that numerous modifications and departures from the specific embodiments described herein may be made without departing from the spirit and scope of the present disclosure.

What is claimed is:

1. A method of selecting an accompanying content for display with a main content, the method comprising:
a. receiving, at a content selection component executing on a computer, a main content identifier (ID) uniquely identifying the main content, the main content requested by a user over a network connection using a computing device, the main content comprising content for presentation to the user on the user computing device;
b. retrieving, from a repository, a main content profile associated with the received main content ID, the main content profile based on extended user profiling information of a plurality of extended knowledge users that have requested the main content associated with the received main content ID; and
c. requesting an accompanying content based on the retrieved main content profile, the accompanying content for presentation to the user with the main content.

2. The method of claim 1 further comprising determining the main content profile comprising:
a. receiving one or more user IDs of users who have previously requested the main content;
b. retrieving extended user profiles associated with each received user ID, each of the extended user profiles comprising a representation of extended user profiling information;
c. calculating a main content profile based upon the retrieved extended user profiles; and
d. storing the main content profile.

3. The method of claim 2 wherein the extended user profile comprises a user profile score determined by collecting events associated with the user's browsing activities and generating a profile based upon the collected events, the profile identifying user preferences in terms of viewed content.

4. The method of claim 3 wherein the profile score for each user is represented as a series of category and category-score pairs, in which the category-score value reflects the relative degree of interest of that user in the category based upon content requests.

5. The method of claim 2 wherein calculating the main content profile is based on a weighted average of the retrieved extended user profiles.

6. The method of claim 5 wherein the weighting is based on the number of times a user has consumed the weighted content.

7. The method of claim 1 wherein the main content profile is a set of category/category-score pairs and/or keyword/keyword-score pairs the categories defining a class of product associated with the content and the keywords defining the subject of the content.

8. The method of claim 7 wherein each keyword is a descriptor that is associated with an event generated by a user, and the keyword-score reflects how strongly the keyword describes or is associated with the event wherein the keyword is part of the content itself or from metadata associated with the event.

9. The method of claim 1 further comprising:
a. generating user events when consumption of main content occurs by one or more users;
b. collecting and aggregating user events generated by consumption of the main content; and
c. generating and updating one or more user profiles for extended knowledge users based upon the aggregated events, the user profiles based upon the extended user profiling information.

10. The method of claim 1 further comprising serving the accompanying content to a lesser knowledge user.

11. The method of claim 1 wherein the accompanying content is selected from the group comprising: a video advertisement; a text advertisement; and a image based advertisement.

12. The method of claim 2 wherein the main content profile is derived based upon one or more categories selected from the group comprising: an overall product/content interests, demographics, psychographics, and other similar characteristic of a subset of users within the extended knowledge user group that has consumed the main content.

13. The method of claim 12 wherein the main content profile is derived by data mining the data that are stored in an aggregate event store or both the aggregate event store and a user profile store.

14. The method of claim 2 wherein main content profiling uses an algorithm is selected based on one or more algorithms selected from the group comprising: an item-based collaborative filtering algorithm, user-based collaborative filtering algorithm, similar nature data mining algorithm, and a heuristic-based algorithm.

15. The method of claim 1 wherein the additional content is displayed alongside the main content to the requesting user.

16. The method of claim 1 further comprising retrieving, from a repository, a user profile associated with the user and wherein requesting the accompanying content for presentation to the user with the main content is based upon the retrieved user profile when the user is an extended knowledge user.

17. The method of claim 1 wherein:
a. the content ID is a universal resource identifier (URI); and
b. the subscriber ID is an internet protocol address (IP).

18. A system for selecting an accompanying content for display with a requested main content, the system comprising:
a. an event generator component comprising a processor for executing instructions and a memory coupled to the processor for storing instructions, the instructions configuring the processor and the memory to generate events, each event associated with a respective user, when consumption of main content occurs by one or more users;
b. an aggregate event store storing on a computer readable memory aggregate event information from the generated events associated with one or more user's that are part of an extended knowledge user group;
c. a main content profiler component comprising a processor for executing instructions and a memory coupled to the processor for storing instructions, the instructions configuring the processor and the memory to generate main content profiles for main content associated with a respective main content identifier (ID) based on the aggregate event information associated with users that have accessed the respective main content;
d. a main content profile store storing on a computer readable medium main content profiles generated by the main content profiler component; and
e. an accompanying content selector component comprising a processor for executing instructions and a memory coupled to the processor for storing instructions, the instructions configuring the processor and the memory to:
i. receive a main content ID uniquely identifying the requested main content, the requested main content requested by a user over a network connection using a computing device, the requested main content comprising content for presentation to the user on the user computing device;
ii. retrieving from the main content profile store the main content profile associated with the main content ID of the requested main content; and
iii. requesting an accompanying content based on the retrieved main content profile, the accompanying content for presentation to the user with the main content.

19. The system as claimed in claim 18, further comprising:
a. a user profiler component operable to:
b. receive one or more events associated with a user ID; and
c. generate, or update, a user profile associated with the user ID,
d. wherein the main content profiler generates the main content profiles for main content associated with a respective main content ID based further on the user profile associated with user IDs of users that have accessed the main content associated with the main content ID.

20. An apparatus for selecting an accompanying content for display with a requested main content, the apparatus comprising:
a. a processor for executing instructions; and
b. a memory coupled to the processor for storing instructions, the instructions configuring the processor and the memory to:
i. receive a main content identifier (ID) uniquely identifying the requested main content, the requested main content requested by a user over a network connection using a computing device, the requested main content comprising content for presentation to the user on the user computing device;
ii. retrieving a main content profile associated with the main content ID of the requested main content, the retrieved main content profile based on aggregate event information stored in an aggregate event store associated with users that have accessed the requested main content; and
iii. requesting an accompanying content based on the retrieved main content profile, the accompanying content for presentation to the user with the main content.
